(19) United States
(12) Patent Application Publication
(10) Pub. No.: US 2009/0186573 A1
(43) Pub. Date: Jul. 23, 2009

(54) Apparatus and method

(75) Inventors: Ville Pernu, Tampere (FI); Jani Okker, Tampere (FI); Jussi Ylanen, Lempaala (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: NOKIA CORPORATION

(21) Appl. No.: 12/073,981

(22) Filed: Mar. 12, 2008

(30) Foreign Application Priority Data
Jan. 21, 2008 (FI) 20085050

(51) Int. Cl. H04Q 7/00

(52) U.S. Cl. 455/26.1

(57) ABSTRACT

An apparatus comprising a first communicator for communicating a first indicator in a first signal line, a second communicator for communicating a second indicator in a second signal line upon the communication of the first indicator in the first signal line, and a controller for control, by using the first and second signal lines, participation in one or more phases of a priority determination cycle for determination of a radio device having an access right to a resource.

### FIELD

The invention relates to an apparatus, a method associated with the apparatus and a computer program product.

### BACKGROUND

The number of different radios in mobile communication devices is steadily increasing to facilitate more flexible connectivity and a broader range of services. Cellular access alone is no longer sufficient, but new wireless technologies are integrated into communication devices today and especially in the future to enable novel connectivity solutions. Integration of multiple radios into a single terminal, however, introduces a serious integration challenge that is becoming more pronounced as the number of radios increases. One element of the integration challenge is the appropriate handling of the simultaneous operation of the radios. It is quite evident that users are willing to use different radios at the same time, like using a headset employing wireless Bluetooth technology during a GSM phone call, and using a wireless local area network (WLAN) connection for Internet surfing, for example.

In a multiradio mobile device, where a number of radio devices, such as modems, coexist in the same device, there is a need to control the power and radio resource usage so that no self-inflicted interference disrupts the device's performance. There is also a need for an arrangement, where adding a new modem to the device may be carried out in a flexible way.

### SUMMARY

In one aspect, there is provided an apparatus, comprising a first communicator configured to communicate a first indicator in a first signal line, a second communicator configured to communicate a second indicator in a second signal line upon the communication of the first indicator in the first signal line, and a controller configured to control, using the first and second signal lines, participation in one or more phases of a priority determination cycle for determination of a radio device having an access right to a resource.

In another aspect, there is provided a method, comprising communicating a first indicator in a first signal line, communicating a second indicator in a second signal line upon the communication of the first indicator in the first signal line, and controlling, using the first and second signal lines, participation in a priority determination cycle including one ore more phases being for determination of a radio device having an access right to a resource.

In still another aspect, there is provided a computer program product, comprising software code portions for executing the method as claimed in any of the method claims.

In still another aspect, there is provided an apparatus, comprising means for communicating a first indicator in a first signal line, means for communicating a second indicator in a second signal line upon the communication in the first signal line, and means for controlling, by using the first and second signal lines, participation in one or more phases of a priority determination cycle for determination of a radio device having an access right to a resource.

### DRAWINGS

In the following the invention will be described in greater detail by means of preferred embodiments with reference to the accompanying drawings, in which

FIG. 1 shows an embodiment of a multiradio device;

FIG. 2 shows an embodiment of a traffic arbitration arrangement in a multiradio device;

FIG. 3 illustrates an embodiment of traffic arbitration;

FIG. 4 shows a signalling diagram of an embodiment of traffic arbitration;

FIG. 5 illustrates an embodiment of traffic arbitration;

FIG. 6 shows a signalling diagram of an embodiment of traffic arbitration; and

FIG. 7 shows an embodiment of a method.

### DESCRIPTION OF EMBODIMENTS

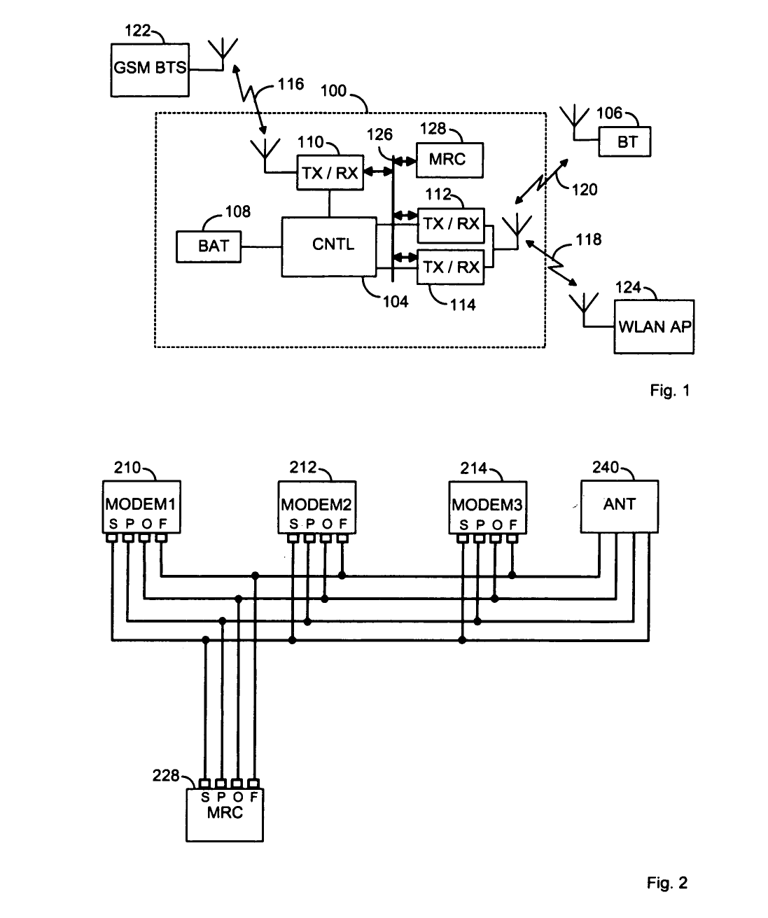

FIG. 1 shows an embodiment of a multiradio device 100. The device may be a mobile phone, computer, a laptop, or a PDA (Personal Digital Assistant), for instance. The device 100 may also be a combination of two electronic devices, such as a computer and a mobile phone connected to the computer. An example of a combination of a PDA and a mobile communication device is the Nokia Communicator.

The device 100 comprises a number of communication interfaces (radio devices) 110 to 114 to provide a wireless radio connection. The communication interfaces 110 to 114 may be configured to provide connections employing different radio access technologies. In our example, the communication interface 110 provides a communication link 116 with a GSM (Global System for Mobile Communications) system through a serving GSM base transceiver station 122. The communication interface 114 provides a WLAN (Wireless Local Area Network) connection 118 with a serving WLAN access point 124. A communication interface 112 provides another wireless connection 120, using Bluetooth technology, with a device 106.

The communication interfaces 110 to 114 described above may share at least partially the same components of the device 100 during the operation of radio connections 116 to 120. The communication interfaces 110 to 114 use for example the same antenna or antennas, radio frequency amplifier, and/or radio frequency filter. Each communication interface 110 to 114 may alternatively have its own components or only some of the communication interfaces 110 to 114 may use the same components.

In the example of FIG. 1, three communication interfaces 110 to 114 are provided in the device, these interfaces 110 to 114 providing the Bluetooth connection 120, the GSM connection 116, and the WLAN connection 118, respectively. It should, however, be appreciated that the device is limited neither to the number of communication interfaces in the device nor to the wireless communication technology the communication interfaces provide. Thus, the device may comprise several communication interfaces providing connections based on, for example, but not limited to, the following technologies: GSM, WLAN, WIMAX, Bluetooth, WCDMA (Wideband Code Division Multiple Access), GPRS (General Packet Radio Service), EDGE (Enhanced Data Rates for GSM Evolution), DVB-H (Digital Video Broadcasting for Handheld devices), UWB (Ultra Wideband), GPS (Global Positioning System), CDMA2000. Other wireless communication technologies may also be implemented in the device.

The device 100 further comprises a control unit 104 to control the functions of the device 100. The control unit 104 comprises means for creating radio connections between the device 100 and other devices or networks. The control unit 104 also comprises means for controlling a number of simultaneous radio connections in the device 100. The control unit 104 may be implemented with a digital signal processor with suitable software or with separate logic circuits, for example with ASIC (Application Specific Integrated Circuit). The control unit 104 may also be a combination of these two implementations, such as a processor with suitable software embedded within an ASIC.

FIG. 1 also shows traffic arbitration bus 126 to which each of the communication interfaces 110 to 114 may be connected. The communication interfaces may send signals to and receive signals from the bus, which may be carried out by setting or reading a signal line value, for instance. These signals may be for the purpose of controlling which of the communication interfaces get radio access and when. A multiradio controller 128 may also be connected to the bus participating in the traffic arbitration between the communication interfaces, that is, the radios of the multiradio device 100.

FIG. 2 shows in more detail an embodiment of a traffic arbitration arrangement in a multiradio device. The multiradio device of FIG. 2 includes radio devices (modems) 210, 212, and 214, and an MRC 228. The modems and MRC are connected to each other with a bus, which is used by the modems and the MRC to arbitrate in real-time which of the devices gets airtime access provided by the transceiver 240. Instead of airtime, the resource to be arbitrated may also be a frequency, a combination of time and frequency, an antenna, or energy, for instance, but not limited thereto. The bus may transfer two or more of the signals shown in the figure, that is S (strobe), P (priority), O (override) and F (feedback) such that the operation mode of the traffic arbitration may be either SP, SPO or SPOF.

The signals on the bus may be open-collector, active low with passive pull-up.

Open collector is a type of output on many integrated circuits (IC). Instead of outputting a signal of a specific voltage or current, the output signal is applied to the base of an internal npn transistor whose collector is open on a pin of the IC. The emitter of the transistor is connected internally to the ground pin.

More than one open-collector output can be connected to a single line. If all outputs attached to the line are in the high-impedance (logic 1) state, the pull-up resistor will hold the wire in a high-voltage state. If one or more of the device outputs are in the ground (logic 0) state, they will sink the current and reduce the line voltage.

By tying the output of several open collectors together, the common line becomes a “wired AND” (positive-true logic) or “wired OR” (negative-true logic) gate. A “wired OR” behaves like the boolean OR for negative-true logic, where the output is LOW if any one of its inputs is low.

Active low means that signal value “1” is represented by a low signal (value “0” of the signal), and “0” by a high signal (value “1” of the signal), that is, the priority bit values are inverted to the signal line.

In the SP-mode only the S- and P-signals are used. This mode is for a case where modems decide amongst themselves which modem gets air access. Thus, in this mode, the MRC does not participate in the traffic arbitration.

The signalling logic uses a serial type of communication. The modems insert their signals to the bus in a sequence where several consecutive signals are interpreted as a binary representation of an integer value. If the modems and their connection streams have eight different priority levels, for instance, the SP-signalling is executed in three phases. If they have 16 priority levels, the SP signalling requires four phases. The number of priority levels goes up with a power of two with respect to the number of phases. S and P are both active low signals.

When any modem wants to initiate air access arbitration, it asserts (i.e. pulls it low) the S (strobe) signal. This generates an interrupt in the other devices, which consequently also pull the strobe low. The strobe signal is de-asserted only when no modem is pulling it low. This ensures that the bus may function according to the slowest of the devices.

As an example, we may consider a situation where the modems may have a priority level from eight possible priority levels, and the first modem (210) has a priority 5 (binary value 101), the second modem (212) has a priority 6 (binary 110) and the third modem (214) has a priority 2 (binary 010). The priority levels may be set by the applications running in the modems through a control interface. Two modems may not have the same priority level. A higher value means a higher priority. These values fit into the range of eight different values, so three phases are required for the traffic arbitration.

All the modems know, for each arbitration or priority determination cycle, how many arbitration phases are required. In the case of a three-bit priority level, for instance, the arbitration cycle will be executed in three arbitration phases. The number of phases may be hard-coded to the modems, or alternatively, it may be an input variable in each modem, for instance. The same number of phases is stored in or communicated to each modem.

The first phase PH1 begins when any modem first asserts the strobe signal. When the strobe goes low, each modem sets their highest bit of the priority value bit to the P (priority) signal line. In this case (notice the inversion), modem 1 (M1) sets “0”, modem 2 (M2) sets “0” and modem 3 (M3) sets “1”. Each modem de-asserts the strobe (stops pulling it low) when they have set their value to the priority signal. As long as any modem is pulling the priority signal low, it remains low. This results in a wired-OR-operation. Thus, in the first phase, modems M1 and M2 are pulling the priority signal low and it remains low.

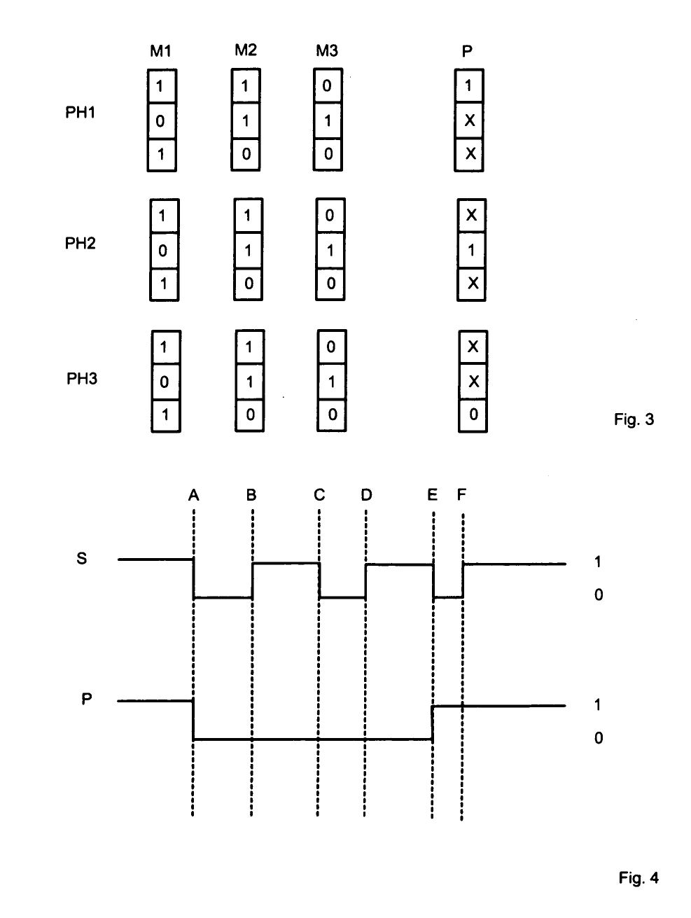

When the strobe rises, modems may evaluate the level of the priority signal. If the signal is different from what they were setting, they quit the contest, since there are higher priority modems attempting access. The modems whose bit value equals to that of the value in the priority signal line continue to the second phase. In the example of FIG. 3, the modems M1 and M2 having value “1” have an equal value to the value in the priority signal and they continue to the next phase, whereas the value “0” of the modem M3 differs from the value in the priority signal and M3 thus quits the contest.

Quitting the contest here means that M3 sets a variable for itself indicating that it will not get air access and will not actively participate in the remaining phases. The modem will thus no longer act on the S and/or P signal lines. The modem may, however, follow the arbitration cycle so that it knows when it ends and when the next arbitration cycle, in which it again should participate, begins. In an embodiment, a timer may be provided for this purpose in the modem. Knowing how long one phase lasts, a timer may be able to tell when the cycle is finished. The modem may then again react upon the next strobe signal or it may itself initiate an arbitration cycle. The second phase PH2 is similar to the first, except that only the modems in contest set their second priority bit to the priority signal line. The modem M1 sets bit “0” and the modem M2 sets “1” (pulls the priority signal low). As there is a modem, which in this case is M2, pulling the priority signal low, it remains low. When the strobe rises, the modems compare the value of the priority signal with the value they set. M1, which is still in the contest, notices that the signal value in the priority signal differs from the value it set, so it will quit the contest.

When the strobe is pulled low for the third phase PH3, only the modem M2 sets the LSB bit value of its priority value to the P-signal line. When the strobe rises, modem M2 compares the bit value “0” it set to the value “0” in the line and finds a match between those. Modem M2 may immediately start performing its air access functions.

Guard intervals may be provided for the time a modem has to hold state between lowering and releasing the strobe, the time the strobe must remain released between phases, and the time all modems must wait before new arbitration is possible after previous arbitration.

FIG. 4 shows a signalling diagram of the signals in the S- and P-signal lines in the example of FIG. 3. Letters A to F illustrate different occurrences in the signal lines P and S.

At time instant “A”, M1 initiates the contest by pulling the strobe low (setting it to 1) and sets its most significant bit (MSB) “1” inverted to the P signal line pulling the priority signal low. At time instant B all the modems have set their MSB to the P-signal line and the final modem releases the strobe signal, which thus rises up. The P-signal line remains low, because modems M1 and M2 continue pulling it low. The time between B and C is used by the modems to evaluate the P-signal value. There may be a guard time for this interval ensuring that even the slowest modems can complete the comparison operation.

At time instant C, the modem M1 as it is the device with the fastest logic in this example, pulls the strobe low and sets its middle bit into the priority signal line. When the strobe goes low, M2 gets the interrupt, also pulls the strobe low and sets its middle bit to the priority signal line. For M1, the middle bit is “0” and for M2 it is “1”, which results in the priority signal staying low. At D, all the modems have set their middle bit to the priority signal line, except M3, which quit the arbitration after PH1, and the strobe rises. The modems again evaluate the P-signal value—M1 notices a difference between its priority value and the P-signal value and quits. At E, the last modem, M2, pulls the strobe low and clears the priority signal. At F, the modem M2 releases the strobe, evaluates the P-signal value and, finding a match between its own value and the P-signal value, starts air access as explained in connection with FIG. 3.

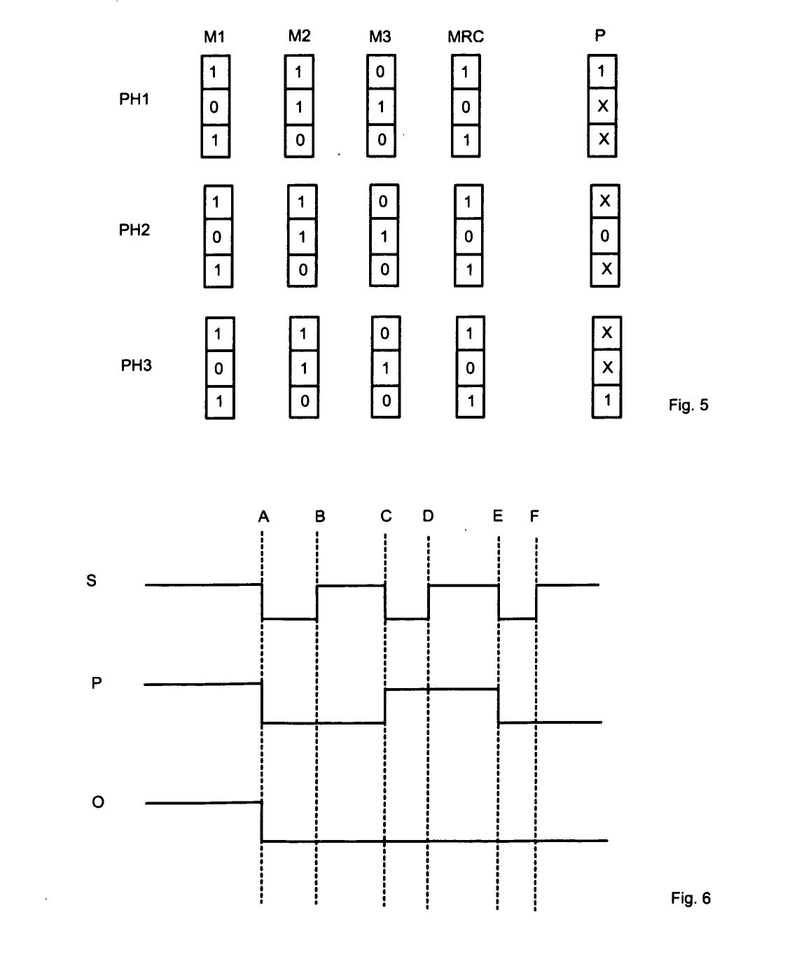

The second mode for traffic arbitration is SPO explained by reference to FIG. 5. This mode is used when the MRC or some other coordinating unit wants to assert a certain modem's priority. The assertion is done with an additional O (override) signal. In the following, the embodiment is explained with reference to MRC without limiting to that the override signal originates from an MRC.

Whenever the MRC makes a decision to force a priority on modems, it pulls the strobe and override low. All the modems evaluate the override when the strobe goes low and reset any arbitration procedures they may have pending.

The arbitration in the SPO mode is again a three-phase cycle for up to eight different priorities. Now, however, instead of modems setting their priority values to the P-signal line, the MRC forces its own value on the P-line by setting the override signal low. The modems compare their own priorities with the forced value, and the one that has an equal value to the forced value, wins the air access right.

The example of FIG. 5 uses the same modem configuration and the same modem priorities as the example in FIG. 3. The MRC begins asserting a priority (in this case 5) by lowering the override and strobe and setting the MSB of the priority value to the P-signal line. The strobe causes an interrupt in all modems. The modems pull the strobe low and release it after the guard time. When the S-signal line is ‘up’ again, each modem compares their priority's MSB with the value in the priority line. In the case of SPO arbitration, the MRC may leave the override signal pulled low for as long as it sees necessary to assert a priority. In this way, when a modem participates in the contest, it will not push its priority value to the P-signal after asserting the strobe, but waits for the MRC to set the value and compares it with its own bit value.

After the first phase PH1 in FIG. 5, the modem M3 knows that the MRC does not allow air access to it. The modem M3 will quit active participation in the contest, which may be done by setting a variable and starting a timer, for instance. In the following phases of this priority determination, the modem M3 reads the variable value and when it notices that it is set, does not act on the S- and P-signal lines. When the timer has elapsed, M3 may unset the variable, where after it may again participate in arbitrations.

The modems M1 and M2 continue to the second phase PH2. After the comparison of the signal value in the priority line (0) with the own values of the modems, the modem M2 notices that air access will not be given to it. The modem M1 continues to the final phase PH3, and because it has the same priority bit value (1) as the one in the priority line (1), M1 concludes that it has obtained the air access right.

A signalling diagram of the SPO example in FIG. 5 is shown in FIG. 6. At time instant A, the MRC pulls the strobe low and sets the override signal to a low value. The modems also pull the strobe. At B, the final modem releases the strobe and the modems compare their MSB with the priority signal value. Modems having no equality quit the contest. In this example, the modem M3 quits.

At C, the modems or the MRC pull the strobe low and the MRC clears the priority signal. At D, the last modem of the modems M1 and M2 still in the contest releases the strobe. At E, the MRC or the remaining modem pulls the strobe low, and the MRC sets the least significant bit to the priority signal line, which in this example means pulling the priority signal low. At F, M1 being the only modem left releases the strobe and finds that the priority signal equals its own signal, thus giving it the air access right.

The third traffic arbitration mode is called SPOF (SPO with feedback). The F-signal is an active-low signal that is pulled low by a modem when its priority value equals the P-signal. This mechanism allows the modems to re-arbitrate their access if the bearer that is asserted by the MRC does not need the allocated time.

When the strobe is pulled low, the modem compares its priority value bit that corresponds to the current arbitration phase to the P-signal. It also releases the F-signal if it has previously been pulling it low. If the P-signal and priority value bit are equal, the modem pulls low the F-signal and releases the strobe.

When the strobe rises (when all modems have released the strobe) the results may be evaluated. If the F-signal is low, at least one modem (or bearer) has the same priority value and the arbitration can proceed to the next phase. If the F-signal is high, no modem has equal value and therefore the arbitration is reset and performed in the SP-mode.

As an example we may consider a situation using the same modem priorities as in the previous examples. We may assume that the MRC initiates assertion for priority 5 (modem M1) as in the SPO-mode. However, in this example the modem 1 is not active and therefore does not participate in the arbitration in any way. During the first phase, the modem 2 has an equal bit in P-signal line and the modem 3 has not. The modem 2 pulls the feedback signal low. During the second phase, the modem 3 is no longer participating and the modem 2 does not have an equal bit to the P-signal. Now, when the strobe rises the F-signal remains high.

The traffic arbitration will then continue in SP-mode between the modems M2 and M3 giving the access right to the modem having the highest priority, which is M2 in this case.

The arbitration in SPOF-mode for up to eight priorities takes 3 to 6 phases depending on the priority values and active bearers (three, if feedback is positive; six, if third phase reveals negative feedback). Other modes, SP and SPO have always fixed three phases for arbitration when eight priority levels are concerned.

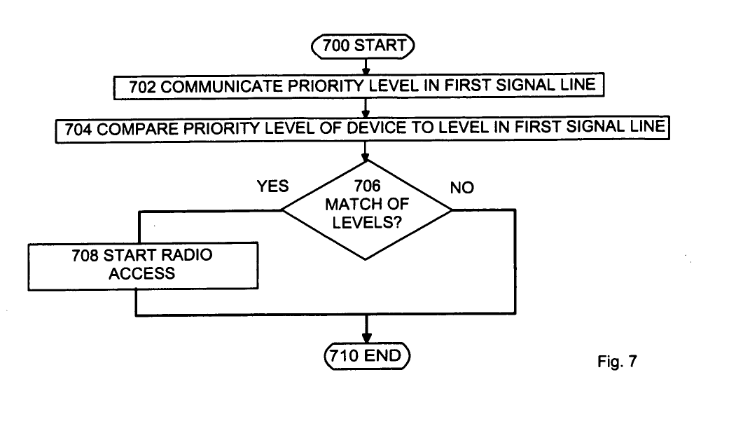

FIG. 7 shows an embodiment of a method. The method presumes two or more multiradio devices being connected to each other via a traffic arbitration bus. The bus may include two to four signal lines, that is S and P, optionally O, and further optionally F.

In 702, a priority level of the radio device getting radio access is communicated. In a first embodiment, the priority level is communicated in an SP-mode. In the SP-mode, the radio devices decide amongst themselves which one gets radio access. The devices may communicate a priority level indicator—one bit of a bit sequence forming the priority level—to the priority signal line. Communication means here that the device may pull down a signal line or clear it. Communication to the priority signal line is preceded by an operation on the strobe signal line. By the use of the strobe signal line, the devices may indicate to the other devices that a priority needs to be determined.

In another embodiment, the arbitration is carried out in an SPO-mode, where priority level is set by a multiradio controller or some other corresponding entity capable of setting a priority by using an override signal. Then, the entity, such as MRC has defined beforehand which device it shall give the access to the resource. By using SP-signalling, the MRC may instruct the device in question that is has the right to access the resource.

In 704, the devices read the priority signal line and compare the indicated priority level with their own priority level. The comparison may be carried out bit-wise. That is, one bit at a time, the device makes a comparison of the values and if there is a match, the device continues to the next phase of the comparison. If the comparison 706 indicates that there is a match even in the last phase of the process, the device concludes that it has got right to the access the resource, such as radio transmission time 708.

The apparatus may be a radio device/interface in a multiradio device including at least two radio devices. Each radio device may provide one of the radio interfaces, such as Bluetooth, GSM or WLAN of the multiradio device. When communicating in the multiradio device, allocation of airtime may be coordinated between the radios of the device. In this allocation, priority levels may be assigned to the radios. The priority levels to different radios may be set and changed by a control unit of the apparatus knowing the applications running in the apparatuses, for instance.

The first communicator may include the entities of the radio device, which connect the radio device to the first signal line, such as strobe signal line. The first communicator may provide the functionality to communicate a first indicator to the first signal line, that is, provide a set and/or unset value to the first signal line. The first communicator may also monitor when the first signal line becomes unset, which occurs when all the radios communicating in the first signal line provide an unset value to the signal line.

The second communicator may correspondingly include the entities for connecting the device into a second signal line, such as the priority signal line, for instance. The second communicator may provide communication therein meaning that the second communicator may provide a set and/or unset value to the second signal line, and evaluate the value of the second signal line when the first signal line becomes unset.

The first and second signal lines may belong to a traffic arbitration bus of the multiradio device, which may also include other signal lines, such as a third signal line and a fourth signal line. The third signal line may be an override signal line, for instance and the fourth signal line may be a feedback signal line, for instance.

The priority level is the total priority level indication used in the apparatus. The priority level may consist of three bits, for instance. A priority level indicator, that is a second indicator, may correspond to one bit in the priority level.

The priority determination in the multiradio device is called priority determination cycle. The priority determination cycle may include a number or priority determination phases. For instance, if the priority level consists of three bits, the priority determination cycle may include three phases.

The priority to the priority line may be set in two ways, either initiated by the radio devices, or initiated by a multiradio controller. When initiated by the radio devices, the radio devices provide a value to the second signal line and evaluate it when all the devices have provided their values, whereas in the other modes they only read the value of the second signal line. Providing of the priority level of the apparatus in a priority determination cycle may be carried out in one or more phases by setting one priority level indicator of the priority level in each phase.

In one embodiment, the apparatus proceeds to a next phase of the priority determination cycle if the priority level indicator of the apparatus equals to the second indicator (signal value) in the second signal line. Thus, after each phase, the radio device may make a decision whether to continue to the next phase of the cycle. If the radio device proceeds to the last phase of the cycle, and its bit value is equal to the value in the line, the radio device wins the access right to the resource. Then for example, a transceiver of the radio may start air access functionalities. If, however, the comparison in the apparatus indicates that the value of the second signal line differs from the value the apparatus set in the second signal line, the apparatus quits participation in the cycle.

The priority signal line value is settable to a set value or an unset value and the second communicator is capable of setting the value of the second signal line, wherein the second signal line remains set if one or more apparatuses sets it to the set value. The second signal line may be an active low signal line, where bit “1” corresponds to a low value (set value) of the signal line and bit “0” corresponds to a high value (unset value) of the signal line.

A radio device may set the first signal to the set value, that is pull it low, upon a need to start a priority contest between the apparatus and other apparatuses connected to the second signal line. The command to start a priority contest (priority determination cycle) may originate from an application running in the apparatus. The first signal may be set to a set value before setting or reading a second indicator to/from the second signal line, and to the unset value when the second indicator has been set/read to/from the second signal line.

The apparatus may also comprise a third communicator configured to communicate in a third signal line, such as an override signal line. This signal line may be configured to communicate a third signal from a multiradio controller, a modem, or some other functional entity. When the third signal line is pulled low by the multiradio controller, for instance, it indicates to the radio devices that the multiradio controller wants to set a priority and allow resource access to one of the radio devices of the multiradio device. When the third signal line is set, the radio devices stop all their ongoing priority level determination cycles, and read the second indicator from the second signal line.

The apparatus may comprise a fourth communicator configured to communicate in a fourth signal line, which may be a feedback signal line having a set and an unset value. The fourth communicator may set an unset value to the fourth signal line if the second signal line value differs from the priority level indicator of the apparatus. That is, if no radio device has equal priority indicator value to the one signalled in the second line after the last phase, the radio devices keep the fourth signal line in the unset value. Thereafter, the controller may start a priority determination cycle using the first and second signal lines. That is, the devices that are still participating in the contest may start traffic arbitration with each other.

The embodiments may be implemented by a combination of software and hardware. For instance, the comparisons of priority levels may be implemented by means of software on a processor of the device. The bus including the signal lines and the connecting interfaces thereof may be implemented by hardware.

It will be obvious to a person skilled in the art that, as technology advances, the inventive concept can be implemented in various ways. The invention and its embodiments are not limited to the examples described above but may vary within the scope of the claims.

1. An apparatus, comprising:
a first communicator configured to communicate a first indicator in a first signal line;
a second communicator configured to communicate a second indicator in a second signal line upon the communication of the first indicator in the first signal line; and
a controller configured to control, by using the first and second signal lines, participation in one or more phases of a priority determination cycle for determination of a radio device having an access right to a resource.

2. The apparatus according to claim 1, wherein the controller is configured to continue participation in the priority determination cycle if a priority level indicator of the apparatus is equal to the second indicator provided in the second signal line.

3. The apparatus according to claim 2, wherein when continuing participation in the priority determination cycle, the controller is configured to proceed to a next phase of the priority determination cycle.

4. The apparatus according to claim 2, wherein when continuing participation in the priority determination cycle, the controller is configured to conclude that the access right to the resource has been granted to the apparatus if the priority level indicator of the apparatus is equal to the second indicator provided in the second signal line in the last phase of the priority determination cycle.

5. The apparatus according to claim 1, wherein the controller is configured to quit participation in the priority determination cycle if the second indicator provided in the second signal line differs from the priority level indicator of the apparatus.

6. The apparatus according to claim 1, wherein the first communicator is configured to provide as a first indicator a set value to the first signal line if the first communicator notices that the first signal line has been set by another apparatus communicating in the first signal line.

7. The apparatus according to claim 1, wherein
the controller is configured to receive an instruction from an application running in the apparatus that a priority level determination cycle has to be started, and
the first communicator is configured to provide as the first indicator a set value to the first signal line indicating to the other apparatuses using the first signal line that a priority determination cycle has to be started.

8. The apparatus according to claim 2, wherein while continuing participation in the priority determination cycle, the second communicator is configured to communicate one priority level indicator of a priority level of the apparatus into the second signal line in each phase of the priority determination cycle.

9. The apparatus according to claim 8, wherein when communicating in the second signal line, the second communicator is configured to evaluate the signal value of the second signal line in the phase of the cycle.

10. The apparatus according to claim 8, wherein while participating in the priority determination cycle, the second communicator is configured to provide a value to the second signal line, and evaluate the value of the second signal line in each phase of the cycle.

11. The apparatus according to claim 1, wherein each phase:
the first communicator to is configured to provide a set value to the first signal line;
the second communicator to communicate a priority level indicator of the apparatus in the second signal line;
the first communicator is configured to provide an unset value to the first signal line;
the first communicator is configured to monitor when the first signal line becomes unset; and
the second communicator is configured to compare the priority level indicator of the apparatus with the second indicator provided in the second signal line.

12. The apparatus according to claim 1, further comprising:
a third communicator configured to communicate in a third signal line.

13. The apparatus according to claim 12, wherein the controller is configured to start a priority determination cycle if the third communicator notices that the third signal line has been set.

14. The apparatus according to claim 12, wherein the controller is configured to stop any ongoing priority determination cycle if the third communicator notices that the third signal line has been set.

15. The apparatus according to claim 1, further comprising:
a fourth communicator configured to communicate a fourth indicator in a fourth signal line; and
the fourth communicator is configured to provide an unset value to the fourth signal line if the second indicator provided in the second signal line differs from the priority level indicator of the apparatus.

16. The apparatus according to claim 15, wherein the controller is configured to start a priority determination cycle using the first and second signal lines if the first communicator notices that the first signal line is unset, and the fourth communicator notices that the fourth signal line is unset.

17. A multiradio device, wherein the multiradio device comprises at least two apparatuses according to claim 1.

18. A method, comprising:
communicating a first indicator in a first signal line;
communicating a second indicator in a second signal line upon the communication of the first indicator in the first signal line; and
controlling, by using the first and second signal lines, participation in a priority determination cycle including one or more phases being for determination of a radio device having an access right to a resource.

19. The method according to claim 18, further comprising:
continuing participation in the priority determination cycle if a priority level indicator of the apparatus is equal to the second indicator provided in the second signal line in a phase of the cycle.

20. The method according to claim 18, further comprising:quitting participation in the priority determination cycle if a priority level indicator of the apparatus is different from the second indicator provided in the second signal line.

21. The method according to claim 18, wherein each phase of the priority determination cycle:
providing a set value to the first signal line;
communicating in the second signal line;
providing an unset value to the first signal line;
monitoring when the first signal line becomes unset;
reading the signal value on the second signal line when the first signal line is unset.

22. The method according to claim 18, further comprising:
communicating in a third signal line capable of providing a third signal;
stopping any ongoing priority determination cycle and starting a new priority determination cycle if the third signal line becomes set.

23. The method according to claim 18, further comprising:
communicating in a fourth signal line;
providing an unset value to the fourth signal line if the second indicator provided in the second signal line differs from a priority level indicator of the apparatus; and
starting a priority determination cycle using the first and second signal lines if the first signal line is unset, and the fourth signal line is unset.

24. A computer program embodied on a computer readable medium comprising program code configured to control a processor to execute a process, the process comprising:
communicating a first indicator in a first signal line;
communicating a second indicator in a second signal line upon the communication of the first indicator in the first signal line; and
controlling, by using the first and second signal lines, participation in a priority determination cycle including one or more phases being for determination of a radio device having an access right to a resource.

25. An apparatus, comprising:
first communicating means for communicating a first indicator in a first signal line;
second communicating means for communicating a second indicator in a second signal line upon the communication in the first signal line; and
controlling means for controlling, by using the first and second signal lines, participation in one or more phases of a priority determination cycle for determination of a radio device having an access right to a resource.
